(19) United States
(12) Patent Application Publication
(10) Pub. No.: US 2014/0182339 A1
(43) Pub. Date: Jul. 3, 2014

(54) GLASS FLOAT CHAMBER

(71) Applicants: Guillaume Bignon, Paris (FR); Fabien Bouillet, Paris (FR); Stephane Gasser, Colmar (FR)

(72) Inventors: Guillaume Bignon, Paris (FR); Fabien Bouillet, Paris (FR); Stephane Gasser, Colmar (FR)

(73) Assignee: SAINT-GOBAIN GLASS FRANCE, Courbevoie (FR)

(21) Appl. No.: 14/236,763

(22) PCT Filed: Jul. 11, 2012
(86) PCT No.: PCT/FR2012/051642

§ 371 Date: Feb. 3, 2014

(30) Foreign Application Priority Data
Aug. 2, 2011 (FR) 11 57075

(51) Int. Cl. C03B 18/16; C03B 18/06

(52) U.S. Cl. CPC C03B 18/16; C03B 18/06
USPC 65/99.5; 65/182.1; 65/99.2

(57) ABSTRACT

A chamber for floating glass on a bath of molten metal including: an upstream wall, a downstream wall, and two lateral walls; rolls for driving the glass in a direction of travel from upstream to downstream; a lateral wall including a shoulder resulting in a reduction in width of the chamber in the direction of travel of the glass, the shoulder starting at a first point and terminating at a second point of the lateral wall, the first and second points being in contact with a surface of the bath of metal, the vertical plane passing through the first and second points forming with the vertical plane, parallel with the direction of travel of the glass and passing through the first point, an angle inside the chamber greater than 150°. Geometric features of the shoulder reduce lateral reciprocal motion of a ribbon emerging from the chamber.

The invention relates to a chamber for floating glass on a bath of molten metal and the use thereof to produce flat glass.

In a glass float chamber, the glass flows via the spout tip onto the bath of tin. To produce thin glass (thickness less than the equilibrium thickness of the glass under consideration, generally approximately 6 mm) said glass is stretched transversely and axially by the action of lateral toothed wheels, called top rolls, and axially by the lehr downstream of the float chamber. To produce thick glass (thickness greater than the equilibrium thickness of the glass under consideration, generally approximately 6 mm), said glass is compressed transversely and stretched axially by the action of the top rolls and stretched axially by the lehr. Thus, to produce thin glass (thickness less than the equilibrium thickness of the glass under consideration, generally approximately 6 mm), after the top roll zone, the glass undergoes a reduction in width called striction. To reduce the quantity of molten metal required (generally tin), to ensure the contact of the lateral actuators (such as the top rolls) with the sheet downstream and to limit evaporation of the metal (generally tin) from its exposed surface, the float chamber has a large width in the region of the zone for pouring and shaping and a smaller width further downstream. The connection between said two zones of different widths is provided by a shoulder which, for ease of design, extends over what is referred to by the person skilled in the art as a “bay”. A “bay” is a structural unit of said installations of which the length is 3.048 m. It is a unit of measurement exclusively in the longitudinal direction of the float chamber. By “longitudinal direction” is understood the direction of flow of the glass in the chamber, said direction being parallel with the axis of the chamber and the axis of the glass ribbon. Float chambers are nowadays constructed by juxtaposing and assembling units (or blocks) totaling 3.048 meters in length (in the longitudinal direction, i.e. the direction of flow of the glass). The shape of the float chambers is largely standardized given that they are enormous installations having to operate uninterrupted for years. Thus risks may not be taken by modifying the overall shape of said chambers. This is why float chambers all have very similar overall shapes. In particular, when they comprise a shoulder in their lateral walls, said shoulder forms an angle close to 135° (angle inside the chamber formed between the wall upstream of the shoulder and the shoulder).

WO2005/073138, U.S. Pat. Nos. 5,862,169, 1,054,371 teach float chambers comprising lateral shoulders substantially forming an angle of 140° with the direction of flow of the glass (angle inside the chamber formed between the wall upstream of the shoulder and the shoulder).

U.S. Pat. No. 4,843,346 teaches a float chamber without a lateral shoulder. Such a chamber is very rare as it is very inflexible. More specifically, it is only suitable for the production of flat glass with a thickness equal to or greater than the equilibrium thickness of the glass under consideration, generally approximately 6 mm.

U.S. Pat. No. 4,115,091 teaches a float chamber comprising a lateral shoulder on the two lateral sides, said shoulders substantially forming an angle of 90° with the direction of flow of the glass.

It has been observed in float chambers comprising lateral shoulders at 125-140° (angle inside the chamber formed between the wall upstream of the shoulder and the shoulder) that the emerging glass ribbon was moved by a slight lateral reciprocal movement. Said slight movement was hitherto unexplained and accepted as an inherent instability in this type of installation. As its amplitude is in the order of several cm, however, it is necessary to allow a slightly larger tolerance when cutting the edges, generating as much loss in glass cullet. The loss in production output is in the order of 1%.

By investigating the movements of convection in the bath of molten metal supporting the glass as it travels along, the reason has now been found for this problem. The bath of metal is more specifically subject to the formation of turbulence in the mixing zone between the forward current (direction of travel of the glass) of the metal driven by the glass and the return current in the region of the uncovered surface of the metal. Two groups of turbulence are discerned, each group being close to a lateral wall of the chamber. Said two groups of turbulence move up the chamber from downstream to upstream, i.e. in the direction opposing the direction of travel of the glass ribbon. It has been observed that at the point furthest downstream in the chamber the turbulence is in phase, i.e. turbulence on the right corresponds to turbulence on the left, and at the same distance from the downstream wall of the chamber. Said groups of turbulence thus move up the chamber “in phase” but the first shoulder in the lateral walls causes a phase reversal: turbulence on the left no longer corresponds to turbulence on the right, but a space between two groups of turbulence. Said phase opposition between the two groups of turbulence on the sides is maintained until they have finished moving up in the direction of the upstream wall of the chamber even if a further shoulder is encountered. Turbulence is associated with a non-uniform temperature of the molten metal. The temperature of one turbulence is substantially higher than the temperature between two groups of turbulence. It is estimated that this difference in temperature is in the order of 20° C. Such a difference in temperature of the liquid metal has a local influence on the viscosity of the glass. Thus, the phase opposition of the turbulence results in a phase opposition of the variations in temperature and viscosity of the glass on its lateral edges. Thus, the top rolls, placed symmetrically on the two sides of the chamber relative to the longitudinal axis of the chamber, bite into the glass with fluctuating viscosity at the edges, the variations in viscosity being in phase opposition from one edge to the other of the ribbon. It is this action of the top rolls on the ribbon to which the viscosity of the edges is in phase opposition which causes said reciprocal lateral movement of the ribbon.

It has already been proposed to place barriers, generally called “flags”, inside the bath of metal in the region of the uncovered part of the molten metal (part not covered by glass) to limit the return currents in the region of the uncovered surface of the metal. The effectiveness thereof is perceptible but still insufficient.

The invention remedies the aforementioned problem. It has been found that it has been possible to eliminate the lateral movement of the ribbon by eliminating the phase opposition of the turbulence in the bath of metal. It has been found that it has been possible to eliminate the phase opposition of the turbulence in the bath of metal by eliminating shoulders which are too abrupt in the lateral walls. According to the invention, the shoulders which are used to reduce the quantities of molten metal in the chamber are not eliminated. More specifically, tin tends to evaporate at these temperatures for floating glass and it is expedient to reduce the exposed surface of molten metal in the chamber. It is thus expedient for the lateral walls of the float chamber to be closer to one another downstream than upstream in the chamber.

The invention primarily relates to a chamber for floating glass on a bath of molten metal comprising an upstream wall, a downstream wall and two lateral walls, rolls for driving the glass in a direction of travel from upstream to downstream, a lateral wall comprising a shoulder resulting in a reduction in the width of the chamber in the direction of travel of the glass, said shoulder starting at a first point and terminating at a second point of the lateral wall, said points being in contact with the surface of the bath of metal, the vertical plane passing through said two points forming with the vertical plane, parallel with the direction of travel of the glass and passing through the first point, an angle inside the chamber which is greater than 150°.

It is the high value of this angle which brings about the smooth progression of the reduction in the distance between the lateral walls in the float chamber when passing from upstream to downstream (term corresponding to the direction of displacement of the glass in the chamber). This angle is also preferably greater than 160° and even more preferably greater than 165°. Generally, this angle is less than 175°.

The shoulder is such that when it is passed, close to the axis of the chamber, the downstream wall is also approached.

The shoulder is generally such that whatever the pair of different points forming part of the shoulder, said points being in contact with the surface of the molten metal, the vertical plane passing through said two points forms with the vertical plane, parallel with the direction of travel of the glass and passing through one or other of the points, an angle inside the chamber which is greater than 150° and preferably greater than 160°.

Generally, the distance between the two lateral walls at the point where the glass leaves the chamber, i.e. in the region of the downstream wall of the chamber, is at least 20% less and often at least 30% less compared with the maximum distance between the two lateral walls. This maximum distance between the two walls is generally in the region where the glass ribbon has its maximum width. This maximum width (of the ribbon and between the walls) is obtained in the shaping zone where the top rolls thereof laterally widen the sheet for the production of thin glass (unless the equilibrium height of the glass is generally less than 6 mm thick). More specifically, it is at this point of shaping the glass that the lateral walls have to be spaced apart from one another to the greatest degree. This maximum width of the glass ribbon is generally at a distance from the upstream wall of between 5 and 30 m. Thus, the invention is particularly suitable for producing flat glass having a thickness of less than 6 mm.

A shoulder in one lateral wall results in a change in direction of the wall between the wall upstream of the shoulder and the shoulder itself. The change in direction is gradual, i.e. it results in an approach without an abrupt shoulder of the wall toward the longitudinal median axis of the chamber. In general, the shoulder starts from a straight portion of wall in the longitudinal direction and terminates at a further straight portion of wall in the longitudinal direction. In the longitudinal direction, the length of the shoulder is greater than 4 m and preferably greater than 5 m, or even greater than 10 m and even greater than 20 m and even greater than 30 m. Generally, in the longitudinal direction, the length of the shoulder is less than 80 m. The length of the shoulder may be less than 60 m. Already a significant improvement is achieved by not producing the shoulder over one “bay” but over the distance of two bays (6.096 m). Thus, according to the invention, the length of the shoulder is generally at least two bays (12.192 m) in the longitudinal direction. The shoulder is itself generally a straight section of wall.

Generally, the shoulder starts at a distance from the upstream wall more than 25% of the total distance between the upstream wall and the downstream wall of the chamber. Generally, the shoulder terminates at a distance from the upstream wall less than 75% of the total distance between the upstream wall and the downstream wall of the chamber. It goes without saying that a shoulder “starts” upstream and “terminates” downstream.

Generally, the chamber is symmetrical relative to a longitudinal median axis. This means that a shoulder in one lateral wall generally corresponds to a shoulder which is symmetrical thereto in the other lateral wall. Each lateral wall thus comprises the shoulder according to the invention, said two shoulders being positioned symmetrically to one another relative to the longitudinal axis of the chamber.

It is possible to place flags in the bath of metal of the chamber according to the invention.

The invention also relates to a method for producing flat glass comprising the floating of glass in a chamber according to the invention. The invention is applicable to thin glass and thick glass (respectively less thick or more thick than the equilibrium thickness of the molten glass on the molten metal). The final flat glass generally has a thickness of between 0.05 mm and 30 mm. In particular, the glass may be stretched transversely and axially by the action of toothed rollers in the float chamber so as to obtain a thinner glass than the equilibrium thickness of the molten glass on the molten metal. Thus, the method according to the invention is particularly suitable for producing flat glass having a thickness of less than 6 mm (between 0.05 and 6 mm). Generally, the distance between the two lateral walls is less than 20%, or even less than 30% in the region of the downstream wall of the chamber, compared with the distance between the two lateral walls in the region where the glass ribbon has its maximum width. Generally, the maximum width of the glass ribbon is located at a distance of between 5 and 30 m from the upstream wall.

The shape of the float chamber according to the invention follows more accurately the shape of the glass ribbon which reduces the exposed surface of tin, not covered by glass, between the sheet of glass and the lateral wall of the chamber. The reduction in the width of the exposed surface on the edges makes it possible to bring together the downstream and upstream currents of tin which improves the transfer by natural conduction and convection within the tin. This leads to a reduction in the temperature difference between the upstream and downstream currents of the tin and thus the amplitude of temporal oscillation of the temperature which causes the instability.

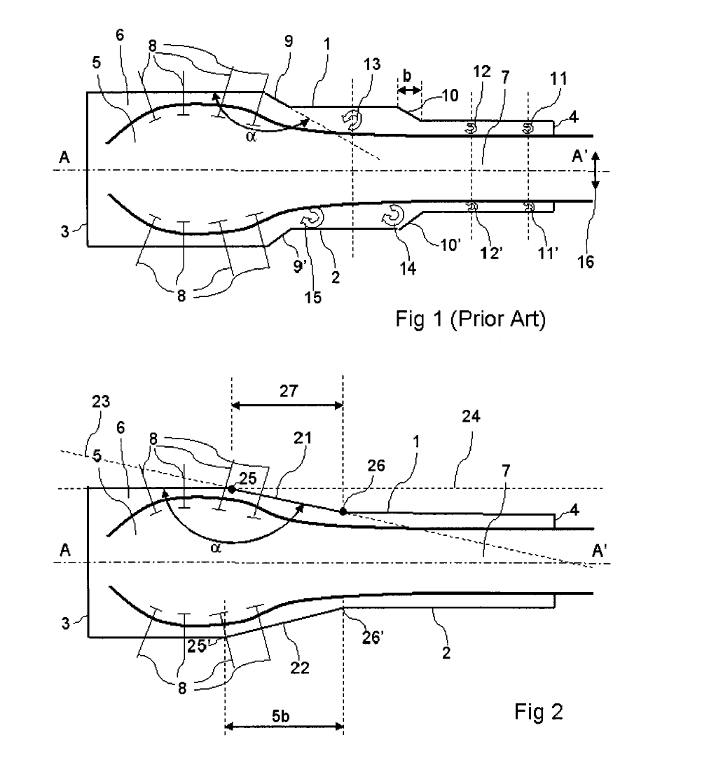

FIG. 1 shows a float chamber according to the prior art. Said chamber is symmetrical relative to its longitudinal median axis AA′ and comprises two lateral walls 1 and 2, an upstream wall 3 and a downstream wall 4. The molten glass 5 is poured upstream onto the bath of metal 6 and is stretched and driven downstream by the top rolls 8 to form a glass ribbon 7. The glass ribbon solidified downstream leaves the chamber via the downstream wall 4. Said ribbon is the source of a reciprocal transverse movement as shown by the double direction arrow 16. It is this movement which is able to be eliminated by the invention. The lateral walls each comprise two shoulders 9, 10, 9′ and 10′. All said shoulders are identical and result in an abrupt reduction of the width of the chamber (distance between lateral walls) over the length of a bay shown by “b” in FIG. 1 in the longitudinal direction. Said shoulders form an angle alpha in the lateral wall of approximately 135° between the upstream wall of the shoulder and the shoulder itself. Turbulence is formed in the bath of metal downstream and moves upstream. The groups of turbulence 11 and 11′ are in phase as they are located at the same distance from the downstream wall (a straight segment in dashed-dotted lines shows their alignment). The same applies to the groups of turbulence 12 and 12′. However, after having passed the shoulders 10 and 10′ it is observed that the groups of turbulence 13, 14 and 15 are no longer in phase.

FIG. 2 shows a float chamber according to the invention. Said chamber is symmetrical relative to its longitudinal median axis AA′ and comprises two lateral walls 1 and 2, an upstream wall 3 and a downstream wall 4. The molten glass 5 is poured upstream onto the bath of metal 6 and is stretched and driven downstream by top rolls 8 to form a glass ribbon 7. The glass ribbon solidified downstream leaves the chamber via the downstream wall 4. The transverse walls each comprise a shoulder 21 and 22. Said shoulders result in an approach of the lateral walls when passing from upstream to downstream. Said shoulders are much more gradual than in the case of FIG. 1. In the longitudinal direction, each shoulder has approximately the length of 5 bays (noted 5b in FIG. 2). The shoulders start respectively at the points 25 and 25′ and terminate respectively at the points 26 and 26′. The vertical plane 23 passes via the start point 25 and finish point 26 of one of the shoulders (lateral left wall in the direction of travel of the glass). It forms an angle alpha with the vertical plane 24 parallel with the direction of travel of the glass and passing via the first point 25, said angle being that inside the chamber. Said angle is greater than 150°. It is seen that each shoulder starts at a distance from the upstream wall more than 25% of the distance between the upstream wall and downstream wall. It is also seen that each shoulder terminates at a distance from the upstream wall less than 75% of the total distance between the upstream wall and the downstream wall of the chamber.

1-16. (canceled)

17. A chamber for floating glass on a bath of molten metal, comprising:
an upstream wall, a downstream wall, and two lateral walls;
rolls for driving the glass in a direction of travel from upstream to downstream;
a lateral wall comprising a shoulder resulting in a reduction in width of the chamber in the direction of travel of the glass, the shoulder starting at a first point and terminating at a second point of the lateral wall, the first and second points being in contact with a surface of the bath of metal,
wherein the vertical plane passing through the first and second points forms with the vertical plane, parallel with the direction of travel of the glass and passing through the first point, an angle inside the chamber which is greater than 150°.

18. The chamber as claimed in claim 17, wherein the angle is greater than 160°.

19. The chamber as claimed in claim 17, wherein the angle is greater than 165°.

20. The chamber as claimed in claim 17, wherein the angle is less than 175°.

21. The chamber as claimed in claim 17, wherein a distance between the two lateral walls is 20% less in a region of the downstream wall of the chamber, compared with a maximum distance between the two lateral walls.

22. The chamber as claimed in claim 17, wherein a distance between the two lateral walls is 30% less in a region of the downstream wall of the chamber, compared with a maximum distance between the two lateral walls.

23. The chamber as claimed in claim 17, wherein a length of the shoulder in the longitudinal direction is greater than 4 m.

24. The chamber as claimed in claim 17, wherein a length of the shoulder in the longitudinal direction is greater than 5 m.

25. The chamber as claimed in claim 23, wherein a length of the shoulder in the longitudinal direction is greater than 10 m.

26. The chamber as claimed in claim 17, wherein a length of the shoulder in the longitudinal direction is less than 80 m.

27. The chamber as claimed in claim 17, wherein the shoulder starts at a distance from the upstream wall more than 25% of a total distance between the upstream wall and the downstream wall of the chamber and the shoulder terminates at a distance from the upstream wall less than 75% of the total distance between the upstream wall and the downstream wall of the chamber.

28. The chamber as claimed in claim 17, wherein the shoulder in one lateral wall corresponds to a shoulder which is symmetrical thereto in an other lateral wall.

29. The chamber as claimed in claim 17,
wherein the shoulder starts at a distance from the upstream wall more than 25% of a total distance between the upstream wall and the downstream wall of the chamber and the shoulder terminates at a distance from the upstream wall less than 75% of the total distance between the upstream wall and the downstream wall of the chamber, and
wherein the shoulder in one lateral wall corresponds to a shoulder which is symmetrical thereto in an other lateral wall.

30. The chamber as claimed in claim 17, wherein the chamber is symmetrical relative to a longitudinal median axis.

31. A method for manufacturing flat glass comprising the floating of the glass in a chamber of claim 17.

32. The method as claimed in claim 31, wherein the glass is stretched transversely and axially by action of toothed rollers in the float chamber.

33. The method as claimed in claim 31, wherein the flat glass has a thickness that is less than its equilibrium thickness on molten metal.

34. The method as claimed in claim 31, wherein the flat glass has a thickness of less than 6 mm.

35. The method as claimed in claim 31, wherein the distance between the two lateral walls is less than 20%, or less than 30% in a region of the downstream wall of the chamber, compared with a distance between the two lateral walls in the region where the glass ribbon has its maximum width.

36. The method as claimed in claim 31, wherein a maximum width of the glass ribbon is located at a distance of between 5 and 30 m from the upstream wall.
